(19) United States
(12) Patent Application Publication
(10) Pub. No.: US 2016/0184806 A1
(43) Pub. Date: Jun. 30, 2016

(54) Method for Preparing Ferrite Catalyst

(71) Applicants: Shanghai HuaYi Acrylic Acid Co., Ltd, Shanghai (CN); Shanghai HuaYi New Material Co., Ltd, Shanghai (CN)

(72) Inventors: Desheng Xiong, Shanghai (CN); Yibin Wang, Shanghai (CN); Yan Zhuang, Shanghai (CN); Ge Luo, Shanghai (CN); Tonghao Wu, Shanghai (CN); Fupeng Zhai, Shanghai (CN); Xiaoxia Wang, Shanghai (CN); Jianxue Ma, Shanghai (CN); Xiaodong Chu, Shanghai (CN); Jinhua Ji, Shanghai (CN)

(21) Appl. No.: 14/959,981

(22) Filed: Dec. 4, 2015

(30) Foreign Application Priority Data
Dec. 25, 2014 (CN) 201410837954.8

(51) Int. Cl. B01J 23/889; B01J 37/04; B01J 37/00; B01J 23/80; B01J 23/78

(52) U.S. Cl. CPC B01J 23/8892; B01J 23/80; B01J 23/78; B01J 37/0036; B01J 37/04

(57) ABSTRACT

Disclosed are a ferrite catalyst, its preparation method and use. The catalyst has a formula of FeAₐD_{b}O_{c}, wherein A is Mg atom, Zn atom or a mixture of these two atoms in any ratio; D is one or more atoms elected from the group consisting of Ni, Co, Mn, Ca, Mo or V; a=0.01˜0.6; b=0˜0.30; c is a number satisfying the valence. The catalyst is prepared by a method comprising mixing the metal oxide precursors according to the chemical ratios and grinding by ball milling to obtain the ferrite catalyst. The catalyst exhibits excellent activity and selectivity when used in a reaction for preparing butadiene by oxidative dehydrogenation of butene. The preparation of the catalyst is simple, controllable and well repeatable, with reduced waste water and waste gas during preparation.

### CROSS-REFERENCE TO RELATED APPLICATIONS

This application claims the benefit of Chinese Patent Application Serial No. CN2014/10837954.8, filed Dec. 25, 2014, which is incorporated herein by reference for all purposes.

### STATEMENT REGARDING FEDERALLY SPONSORED RESEARCH OR DEVELOPMENT

Not applicable.

### FIELD OF INVENTION

The present invention relates to a catalyst for the preparation of butadiene by oxidative dehydrogenation of butene, which exhibits high conversion rate of butene and high selectivity for butadiene. The present invention further relates to a method for preparing the catalyst and use of the catalyst in the preparation of butadiene by oxidative dehydrogenation of butene.

### BACKGROUND OF THE INVENTION

Butadiene is a monomer used in a greatest amount among monomers used in the synthetic rubber industry. It is also an important intermediate used for the production of synthetic rubber and organic chemical raw material. Butadiene may be used to synthesize styrene butadiene rubber, cis-polybutadiene, nitrile butadiene rubber, chloroprene rubber and ABS resin, etc.

Currently, butadiene is mainly extracted from the by-product of naphtha formed during cracking. However, as development of requirement on light raw materials for ethylene and propylene, the yield of the cracking apparatus for naphtha is gradually reduced. Thus, the extracted butadiene did not satisfy the ever-growing need of butadiene. There is an increasing gap in the market for butadiene. Therefore, there is a need to develop a new process for the production of butadiene that is independent on cracking of alkene.

In the 1960's, the technique for producing butadiene by oxidative dehydrogenation of butene was industrialized. Catalyst used for oxidative dehydrogenation of butene was mainly a ferrum-based spinel catalyst. For example, Petro-Tex Corp. of USA has disclosed a process for oxidative dehydrogenation of butene by using a ferrum-based spinel catalyst, which process had 78%-80% of butene conversion rate and 92%-95% of butadiene selectivity. Ferrum-based catalysts, such as B-02, H-198 and W-201 and the like were also developed in China in 1980's, which were used in the industrial production.

Ferrite catalyst has a structure of spinel AFe₂O₄, wherein A is Zn, Co, Ni, Mg and Cu, etc. Ferrite catalyst can be used in an oxidative dehydrogenation reaction through oxidation and reduction of ferric ion and interaction between oxygen ion and gaseous oxygen within the crystal. Zinc ferrite, magnesium ferrite and manganese ferrite, etc., are relatively suitable for oxidative dehydrogenation of butene, with zinc ferrite having the highest selectivity for butadiene among the ferrites.

It was known that the preparation process of the ferrite catalyst and the element composition of the catalyst may affect the activity of the catalyst. Activity and selectivity for butadiene of the catalyst in the oxidative dehydrogenation could be improved by modifying the preparation process, adding beneficial metal element, as well as pretreating or post treating the catalyst.

For example, Petro-Tex Chemical Corporation reported in U.S. Pat. No. 3,937,748 to prepare a zinc ferrite catalyst via a co-precipitation method by using ammonia as a co-precipitator . The ferrite catalyst thus prepared exhibits better activity and prolonged working life as compared with the ferrite catalyst prepared by high temperature solid state reaction. Lanzhou Institute of Chemical Physics CAS reported to use ammonia as a precipitator to prepare a ferrite catalyst by a co-precipitation method. They introduced the formulation and preparation process of the ferrite catalyst, and how the reaction parameters affect on the performance of the catalyst.

U.S. Pat. No. 4,020,120 disclosed a method for preparing a ferrite catalyst, which used ferric oxide, zinc carbonate, and zinc chloride as raw materials, and said method comprised to disperse the solid raw materials in an aqueous solution to form a paste, filter, dry the filter cake, mold, and calcine same under high temperature to obtain the ferrite catalyst.

The above-mentioned ferrite catalysts were all prepared by a co-precipitation method or a high temperature solid state reaction. These methods have complicated preparation procedures and poor repeatability, with loss of metal ion and production of a large amount of waste water and waste gas which are difficult to be treated.

Mechanochemistry (also called “high-energy ball milling”) is a method for preparing a superfine material. The basic mechanism of mechanochemistry is to utilize a mechanical energy to induce a chemical reaction or to induce change in composition, structure and property of the material, so as to prepare a new material. As a new technique, it can significantly reduce the activation energy of a reaction, fine the crystal grain, greatly enhance the activity of the powder and improve homogenous distribution of the particles, and increase the interface binding among matrixes. It can also promote solid ion diffusion and induce a chemical reaction under low temperature to improve the properties, such as, degree of compaction, electric and thermal properties, of the material. Thus, it is an energy efficient and high efficient technique for preparing a material.

Therefore, there is still a need in the art to develop a ferrite catalyst for preparing butadiene by oxidative dehydrogenation of butene, which exhibits high conversion rate of butene and high selectivity for butadiene and which preparation is simple, controllable and well repeatable, together with reduced waste water and waste gas during preparation.

### BRIEF SUMMARY OF THE INVENTION

One object of the present invention is to provide a ferrite catalyst for preparing butadiene by the oxidative dehydrogenation of butene, which exhibits high conversion rate of butene and high selectivity for butadiene.

Another object of the present invention is to provide a method for preparing the ferrite catalyst, which method has a simple and repeatable procedure with no metal ion loss and no production of waste water and waste gas, etc as compared with the conventional method.

Further object of the present invention is to provide use of the ferrite catalyst in a reaction for preparing butadiene by the oxidative dehydrogenation of butene.

Therefore, in one aspect, the present invention provides a ferrite catalyst having the following structural formula:

FeAₐD_{b}O_{c}

wherein:

A is Mg atom, Zn atom or a mixture of these two atoms in any ratio;

D is one or more atoms selected from the group consisting of Ni atom, Co atom, Mn atom, Ca atom, Mo atom or V atom, preferably one or more of Co atom, Mn atom or Ni atom;

a=0.01˜0.6;

b=0˜0.30;

c is a number satisfying the valence.

The catalyst is prepared by a method comprising:

(i) mixing the metal oxide precursors according to the chemical ratios; and

(ii) ball milling the mixture of the oxide precursors to obtain the catalyst.

In another aspect, the present invention provides a method for preparing the above catalyst, comprising the following steps:

(1) sieving the desired metal oxide precursors to obtain particles having a particle size of less than 0.2 mm, weighing according to the chemical ratios, and mixing;

(2) ball milling the mixture of the oxides to obtained the desired ferrite catalyst.

In another aspect, the present invention relates to use of ball milling in the preparation of a catalyst for preparing butadiene by the oxidative dehydrogenation of butene.

### DETAILED DESCRIPTION OF THE INVENTION

### Best Mode for Carrying Out the Invention

1. Ferrite Catalyst

The present invention relates to a ferrite catalyst, which exhibits improved conversion rate of butene and selectivity for butadiene in a reaction for preparing butadiene by the oxidative dehydrogenation of butene.

The ferrite catalyst of the present invention has the following structural formula:

FeAₐD_{b}O_{c}

wherein:

A is Mg atom, Zn atom or a mixture of these two atoms in any ratio.

A) is 0.01˜0.6, preferably 0.05˜0.5, more preferably 0.1˜0.4. In one embodiment of the present invention, a represents a numerical range formed by any two of the followings as end points : 0.01, 0.6, 0.05, 0.5, 0.1 and 0.4.

D) is one or more atoms selected from the group consisting of Ni atom, Co atom, Mn atom, Ca atom, Mo atom or V atom, preferably one or more of Co atom, Mn atom or Ni atom;

B) is 0˜0.30; preferably 0.02˜0.20, more preferably 0.05-0.15, most preferably 0.08-0.10. In a preferred embodiment of the present invention, b represents a numerical range formed by any two of the followings as end points: 0.02, 0.20, 0.05, 0.15, 0.08 and 0.10;

C) is a number satisfying the valence.

In one embodiment of the present invention, examples of the ferrite include, but not limited to, Fe_{1.0}Zn_{0.5}O₄, Fe_{1.0}Mg_{0.5}O₂, Fe_{1.0}Zn_{0.4}Mg_{0.02}Co_{0.02}O_{1.93}, and Fe_{1.0}Zn_{0.4}Mg_{0.02}Mn_{0.05}O_{1.93.}

2. Method for Preparing the Ferrite Catalyst

The ferrite catalyst of the present invention can be prepared by the following method:

(1) Grinding the desired metal oxide precursors and sieving to obtain particles having a particle size of less than 0.2 mm and then mixing homogenously.

The oxide precursor may be a single oxide, or may be a mixture of several metal oxides, depending on the processes of the method. The metal oxide may be prepared by a precipitation method, a hydrothermal method, a thermal decomposition method or the like.

The metal oxide precursor needs to be sieved to a certain particle size. Small particle size will be beneficial for shortening the time of the subsequent high energy ball milling. In a preferred embodiment of the present invention, the metal oxide is sieved to obtain particles having a particle size of less than 0.2 mm, preferably less than 0.15 mm, more preferably less than 0.1 mm, and most preferably less than 0.07 mm.

(2) Weighing the metal oxide precursors according to the chemical ratio, placing same in a ball milling jar, adding milling balls and ball milling.

The mass ratio of the milling balls, such as stainless steel balls, and the precursors is 50˜5:1. The oscillation frequency of the ball mill is 20˜30 Hz, and the milling time is set to 10˜1000 minutes. After ball milling, the ferrite catalyst used for preparation of butadiene by the oxidative dehydrogenation of butene can be produced.

The atmosphere within the ball milling jar is not specifically limited, which can be air, nitrogen gas or other inert gases.

In one embodiment of the present invention, the mass ratio between the stainless steel ball and the precursors as raw materials is 50˜5:1, preferably 30˜10:1, more preferably 20˜12:1. In a preferred embodiment of the present invention, the mass ratio falls within a scope formed by any two of the followings as end points: 50,5,30,10,20 and 12. If the mass ratio between the stainless steel ball and the raw material is lower than the above range, a long time will be required to complete a solid state reaction among the metal oxide precursors, resulting in poor catalyst producing efficiency. If the mass ratio between the stainless steel ball and the raw material is higher than the preferred range, efficiency for preparing the catalyst will not be further improved with the increase of the mass ratio.

The preferred oscillation frequency of the ball mill is 20˜30 Hz, more preferably 22≠28 Hz, and most preferably 24˜28 Hz. If the oscillation frequency of the ball mill is too low, the duration for completing the solid state reaction among oxide precursors will be long and the efficiency of preparing the catalyst will be very low. If the oscillation frequency of the ball mill is too high, the ball mill will be unable to continuously work due to un-timely heat emission.

The preferred milling time is set to 10˜1000 minutes, more preferably 30˜800 minutes, and most preferably 120˜600 minutes. If the milling time is too short, solid phase reaction among the metal oxide precursors will be insufficient and the produced ferrite will not have enough active substance, resulting in poor catalytic performance. However, if the milling time is prolonged after the solid state reaction among the metal oxide precursors is completed, the performance of the catalyst will not be further enhanced, which, on the contrary, may increase the energy consumed for preparation of the catalyst.

3. The Use of the Ferrite Catalyst of the Present Invention

The ferrite catalyst of the present invention is suitable for use in a reaction of preparing butadiene by oxidative dehydrogenation of butene. A typical reaction may comprise the following steps: homogeneously mixing butane, as a raw material, water vapor, air and a diluent gas; pre-heating same, and passing the pre-heated mixture to a catalyst bed to perform an oxidative dehydrogenation under the following reaction conditions: a reaction temperature of 250-550° C., a space velocity of 100˜1,000 h⁻¹ with respect to butene as a raw material, a volume concentration of butene in the reaction gas being 1˜20%, and a molar ratio of butene:oxygen:water vapor:diluent gas being 1:0.2˜2:1˜20:0˜20; and the diluent gas is one of nitrogen gas, argon gas and helium gas.

In one embodiment, the reaction for preparing butadiene by oxidative dehydrogenation of butene comprises the following steps: preheating a mixture of butane as a raw material, water vapor, air and a diluent gas, pre-heating same, and passing the pre-heated mixture to a catalyst bed for oxidative dehydrogenation under the following reaction conditions: a reaction temperature of 300-450° C., a space velocity of 300˜600 h⁻¹ with respect to butene as a raw material, a volume concentration of butane being 4˜12%, and a molar ratio of butene:oxygen:water vapor:diluent gas being 1:0.5˜1:3˜16:0˜10; and the diluent gas is nitrogen gas.

In the present reaction for preparing butadiene by oxidative dehydrogenation of butene, the ferrite catalyst prepared by the method of the present invention is used in the catalyst bed.

The raw material may be one of 1-butene, trans-2-butene and cis-2-butene, or a mixture of any two or three thereof.

The present invention is further illustrated by making reference to the Examples. In the following Examples, the conversion rate of butene and the selectivity for butadiene are calculated according to the following formulae:

Conversion rate of butene (%)={[(the weight of butene before reaction)−(the weight of butene after reaction)]/(the weight of butene before reaction)}×100%

Selectivity for butadiene(%)=(the weight of butadiene produced)/(the weight of butene reacted)×100%

### Example 1

1. Preparation of Catalyst

Fe₃O₄ and ZnO were ground and sieved respectively to obtain particles having a particle size of less than 0.07 mm or less than 200 meshes. 7.718 g Fe₃O₄ and 4.069 g ZnO were weighed, placed in a grinding bowl and manually ground for 5 minutes to mix same homogeneously. The mixture was then transferred to a 50 ml stainless steel ball milling jar. 180 g stainless steel balls were added for milling. The velocity of ball milling was 28 Hz and the time of milling was 2 hours, thereby producing an active substance of the ferrite catalyst. The resultant catalyst powder was mixed with graphite in an amount that the graphite comprised 3% of the total mass. The mixed powder was molded to form particles having a particle size of 20˜40 meshes to produce the catalyst.

After analysis of element composition of the catalyst powder by ICP, it was found that the composition of the catalyst was Fe_{1.0}Zn_{0.5}O₄. The molar ratio between Fe and Zn was identical to that in the raw material initially added, indicating that no metal ion lost during preparation. It was found that the catalyst powder exhibited a pure Fe₂Zn₁O₄ spinel crystal phase, as demonstrated by analysis of the crystal phase of the catalyst by X-ray powder diffraction, indicating that a solid state reaction was taken place between Fe₃O₄ and ZnO, forming active substance of the zinc ferrite catalyst after high energy ball milling.

2. Evaluation of Performance of the Catalyst by Dehydrogenation of Butene

5 ml of the catalyst were loaded into a stainless steel tubular reactor to test the performance of the catalyst. The inner diameter of the stainless steel tubular reactor was 10 mm and the length was 350 mm.

The raw material 1-butene was mixed with water vapor and air. After pre-heated to 300° C., the mixture was passed through the catalyst bed. The space velocity of 1-butene was 400 h⁻¹, the reaction temperature was 350° C., the molar ratio between oxygen and butene was 0.7, and the molar ratio between water vapor and butene was 12. 20 hours after the reaction was stable, the tail gas was analyzed on-line by gas chromatography.

As calculated based on the above formulae, the conversion rate of 1-butene was 78% and the selectivity for butadiene was 93.8%.

### Comparative Example 1

1. Preparation of Catalyst (Calcination)

Ferrite catalyst was prepared by high temperature solid state reaction. 7.718 g Fe₃O₄ (having a particle size of less than 200 meshes) and 4.069 g ZnO (having a particle size of less than 200 meshes) were weighed and placed in a grinding bowl and manually ground for 5 minutes to mix same homogeneously. Then the powder was transferred to a crucible. The crucible was placed to a muffle furnace for calcination in air at 800° C. for 4 hours.

After analysis of element composition of the catalyst powder by ICP, it was found that the composition of the catalyst was Fe_{1.0}Zn_{0.5}O₄. The molar ratio between Fe and Zn was identical to that in the raw material initially added, indicating that no metal ion lost during preparation. It was found that the catalyst powder exhibited Fe₂Zn₁O₄ spinel crystal phase, ZnO crystal phase and Fe₂O₃ crystal phase, as demonstrated by analysis of the crystal phase of the catalyst by X-ray powder diffraction, indicating that no sufficient solid state reaction was taken place between the oxides by directly using the high temperature solid state reaction, thereby no pure ferrite catalyst was obtained.

2. Evaluation of Performance of the Catalyst by Dehydrogenation of Butene

The performance of the catalyst was tested by the same method as in Example 1. The space velocity of 1-butene was 400 h⁻¹, the reaction temperature was 360° C., the molar ratio between oxygen and butene was 0.7, and the molar ratio between water vapor and butene was 12. 20 hours after the reaction was stable, the tail gas was analyzed online by gas chromatography. As calculated based on the analytic results, the conversion rate of 1-butene was 55% and the selectivity for butadiene was 82%.

### Comparative Example 2

1. Preparation of Catalyst (Co-Precipitation)

Ferrite catalyst was prepared by co-precipitation. 404 g ferric nitrate and 148.7 g zinc nitrate were dissolved in 2,000 g distilled water. The molar ratio between Fe and Zn was 2:1. Strong ammonia was slowly dropped into the nitrate solution while stirring until the pH of the solution reached 8.0. The resultant slurry was allowed aging for 1 hour at ambient temperature, filtered and washed by distilled water until it reached a neutral pH. The resultant filter cake was placed in an oven for drying at 120° C. for 24 hours. The dried solid was ground, sieved and mixed with graphite. The graphite comprised 3% of the total mass. The mixed powder was molded to form particles having particle size of 20-40 meshes, and then warmed up to 650° C. for a heat treatment for 10 hours in an air atmosphere to produce the catalyst.

After analysis of element composition of the catalyst powder by ICP, it was found that the composition of the catalyst was Fe_{1.0}Zn_{0.41}O_{1.91}. The molar ratio between Fe and Zn was greater than that in the raw material initially added, indicating that Zn ion lost during preparation. The filtrate obtained during preparation of the catalyst was analyzed by ICP. It was found that the concentration of Zn ion was 0.012 mol/L and no Fe ion was detected, indicating that Zn ion could not be completely precipitated during preparation of the catalyst by co-precipitation and a portion of the Zn ion was lost by dissolving in the solution. The waste water could be discharged during an industrial production of the catalyst only after the Zn ion was removed from the waste water.

It was found that the catalyst powder exhibited an Fe₂Zn₁O₄ spinel crystal phase and Fe₂O₃ crystal phase, which was not pure ferrite structure, as demonstrated by analysis of the crystal phase structure of the final catalyst by X-ray powder diffraction.

2. Evaluation of performance of the catalyst by dehydrogenation of butene

The performance of the catalyst was tested by the same method as in Example 1. The space velocity of 1-butene was 400 h⁻¹, the reaction temperature was 330° C., the molar ratio between air and butene was 3.3, and the molar ratio between water vapor and butene was 12. 20 hours after the reaction was stable, the tail gas was analyzed online by gas chromatography. As calculated based on the analytic results, the conversion rate of 1-butene was 75% and the selectivity for butadiene was 92.5%.

### Example 2

1. Preparation of Catalyst

Fe₃O₄ and MgO were ground and sieved respectively to obtain particles having a particle size of less than 0.07 mm or less than 200 meshes. 7.718 g Fe₃O₄ and 2.015 g MgO were weighed and placed in a grinding bowl and manually ground for 5 minutes to mix same homogeneously. The mixture was then transferred to a 50 ml stainless steel ball milling jar. 120 g stainless steel balls were added for milling. The velocity of ball milling was 25 Hz and the time of milling was 5 hours, forming an active substance of the ferrite catalyst. The resultant catalyst powder was mixed with graphite in an amount such that the graphite comprised 3% of the total mass. The mixed powder was molded to form particles having a particle size of 2040 meshes to produce the catalyst.

After analysis of element composition of the catalyst powder by ICP, it was found that the composition of the catalyst was Fe_{1.0}Mg_{0.5}O₂. The molar ratio between Fe and Mg was identical to that in the raw material initially added, indicating that no metal ion lost during preparation. It was found that the catalyst powder exhibited a pure Fe₂Mg₁O₄ spinel crystal phase, as demonstrated by analysis of the crystal phase of the catalyst by X-ray powder diffraction, indicating that solid state reaction was taken place between Fe₃O₄ and MgO to produce the active substance of the magnesium ferrite catalyst after high energy ball milling.

2. Evaluation of Performance of the Catalyst by Dehydrogenation of Butene

5 ml of the catalyst were loaded into a stainless steel tubular reactor to test the performance of the catalyst. The inner diameter of the stainless steel tubular reactor was 10 mm and the length was 350 mm.

The raw material 1-butene was mixed with water vapor and air. After pre-heated to 300° C., the mixture was passed through the catalyst bed. The space velocity of 1-butene was 400 h⁻¹, the reaction temperature was 350° C., the molar ratio between oxygen and butene was 0.7, and the molar ratio between water vapor and butene was 12. 20 hours after the reaction was stable, the tail gas was analyzed on-line by gas chromatography.

As calculated based on the above formulae, the conversion rate of 1-butene was 75% and the selectivity for butadiene was 94.2%.

### Example 3

1. Preparation of Catalyst

Fe₃O₄, ZnO, MgO and Co₃O₄ were ground and sieved respectively to obtain particles having a particle size of less than 0.07 mm or less than 200 meshes. 7.718 g Fe₃O₄, 3.255 g ZnO, 0.081 g MgO and 0.162 g Co₃O₄ were weighed and placed in a grinding bowl and manually ground for 5 minutes to mix same homogeneously. The mixture was then transferred to a 50 ml stainless steel ball milling jar. 200 g stainless steel balls were added for milling. The velocity of ball milling was 25 Hz and the time of milling was 3 hours, forming an active substance of the ferrite catalyst. The resultant catalyst powder was mixed with graphite in an amount such that the graphite comprised 3% of the total mass. The mixed powder was molded to form particles having a particle size of 20˜40 meshes to produce the catalyst.

After analysis of element composition of the catalyst powder by ICP, it was found that the composition of the catalyst was Fe_{1.0}Zn_{0.4}Mg_{0.02}Co_{0.02}O_{1.93}. The molar ratio among Fe, Zn, Mg and Co was identical to that in the raw material initially added, indicating that no metal ion lost during preparation. It was found that the catalyst powder exhibited Fe₂Zn₁O₄ ferrite crystal phase and Fe₂O₃ crystal phase, as demonstrated by analysis of the crystal phase of the catalyst by X-ray powder diffraction, indicating that solid state reaction was taken place, producing the active substance of ferrite catalyst after high energy ball milling.

2. Evaluation of Performance of the Catalyst by Dehydrogenation of Butene

5 ml of the catalyst were loaded into a stainless steel tubular reactor to test the performance of the catalyst. The inner diameter of the stainless steel tubular reactor was 10 mm and the length was 350 mm.

The raw material 1-butene was mixed with water vapor and air. After pre-heated to 300° C., the mixture was passed through the catalyst bed. The space velocity of 1-butene was 400 h⁻¹, the reaction temperature was 320° C., the molar ratio between air and butene was 0.7, and the molar ratio between water vapor and butene was 12. 20 hours after the reaction was stable, the tail gas was analyzed on-line by gas chromatography.

As calculated based on the above formulae, the conversion rate of 1-butene was 88% and the selectivity for butadiene was 95.2%.

### Comparative Example 3

1. Preparation of Catalyst

Ferrite catalyst was prepared by co-precipitation. Specifically, 404 g ferrum nitrate, 148.7 g zinc nitrate, 2.96 g magnesium nitrate, and 5.82 g cobalt nitrate were dissolved in 2,000 g distilled water with a molar ratio among Fe ion, Zn ion, Mg ion and Co ion being 1:0.4:0.02:0.02. Strong ammonia was slowly dropped into the nitrate solution while stirring until the pH of the solution reached 8.0. The resultant slurry was allowed for aging for 1 hour under ambient temperature and filtered. The filter cake was washed three times by total 1,000 g distilled water and was placed in an oven for drying at 120° C. for 24 hours. The dried solid was ground, sieved and mixed with graphite. The graphite comprised 3% of the total mass. The mixed powder was molded to form particles of 2040 meshes, and then warmed up to 650° C. for a heat treatment for 10 hours in an air atmosphere to produce the catalyst.

After analysis of element composition of the catalyst powder by ICP, it was found that the composition of the catalyst was Fe_{1.0}Zn_{0.35}Mg_{0.001}Co_{0.001}O_{1.85}. The filtrate obtained during preparation of the catalyst was analyzed by ICP. It was found that the concentration of Zn ions was 0.011 mol/L, the concentration of Mg ions was 0.00475 mol/L, the concentration of Co ions was 0.00225 mol/L, and no Fe ions were detected, indicating that Zn ions, Mg ions and Co ions could not completely be precipitated during preparation of the catalyst by co-precipitation. Co ion and Mg ion lost greatly. The waste water could be discharged during an industrial production of the catalyst only after the Zn ion were removed from the waste water.

It was found that the catalyst powder exhibited an absolute Fe₂Zn₁O₄ spinel crystal phase and Fe₂O₃ crystal phase, which was not pure ferrite structure, as demonstrated by analysis of the crystal phase structure of the final catalyst by X-ray powder diffraction.

2. Evaluation of Performance of the Catalyst by Dehydrogenation of butene

The performance of the catalyst was tested by the same method as in Example 1. The space velocity of 1-butene was 400 h⁻¹, the reaction temperature was 350° C., the molar ratio between air and butene was 0.7, and the molar ratio between water vapor and butene was 12. As calculated based on the analytic results, the conversion rate of 1-butene was 78% and the selectivity for butadiene was 93.0%.

### Example 4

1. Preparation of Catalyst

Fe₃O₄, ZnO, MgO and MnO were ground and sieved respectively to obtain particles having a particle size of less than 0.07 mm or less than 200 meshes. 7.718 g Fe₃O₄, 3.255 g ZnO, 0.081 g MgO and 0.354 g MnO were weighed and placed in a grinding bowl and manually ground for 5 minutes to mix same homogeneously. The mixture was then transferred to a 50 ml stainless steel ball milling jar. 100 g stainless steel balls were added for milling. The velocity of ball milling was 30 Hz and the time of milling was 0.5 hours, thereby producing an active substance of the ferrite catalyst. The resultant catalyst powder was mixed with graphite in an amount such that the graphite comprised 3% of the total mass. The mixed powder was molded to form particles having particle size of 20˜40 meshes to produce the catalyst.

After analysis of element composition of the catalyst powder by ICP, it was found that the composition of the catalyst was Fe_{1.0}Zn_{0.4}Mg_{0.02}Mn_{0.05}O_{1.93}. The molar ratio among Fe, Zn, Mg and Mn was identical to that in the raw material initially added, indicating that no metal ion lost during preparation. It was found that the catalyst powder exhibited zinc ferrite crystal phase and Fe₂O₃ crystal phase, as demonstrated by analysis of the crystal phase of the catalyst by X-ray powder diffraction, indicating that solid state reaction was taken place among the oxides, producing the active substance of the ferrite after high energy ball milling.

2. Evaluation of Performance of the Catalyst by Dehydrogenation of Butene

5 ml of the catalyst were loaded into a stainless steel tubular reactor to test the performance of the catalyst. The inner diameter of the stainless steel tubular reactor was 10 mm and the length was 350 mm.

The raw material 1-butene was mixed with water vapor and air. After pre-heated to 300° C., the mixture was passed through the catalyst bed. The space velocity of 1-butene was 400h⁻¹, the reaction temperature was 320° C., the molar ratio between air and butene was 0.7, and the molar ratio between water vapor and butene was 12. 20 hours after the reaction was stable, the tail gas was analyzed on-line by gas chromatography.

As calculated based on the above formulae, the conversion rate of 1-butene was 85% and the selectivity for butadiene was 94.8%.

By comparing the results obtained from the Examples with those from Comparative Examples, it can be found that the method of the present invention has a simple procedure and excellent repeatability, with no metal ions loss and no production of metal ion-containing waste water. The catalyst prepared by the present method has an excellent performance, high activity and high selectivity for butadiene when using for oxidative dehydrogenation of butene.

What is claimed is:

1. A ferrite catalyst having the following structural formula:
FeAₐD_{b}O_{c}
wherein
A is Mg atom, Zn atom or a mixture of these two atoms in any ratio;
D is one or more atoms selected from the group consisting of Ni atom, Co atom, Mn atom, Ca atom, Mo atom or V atom;
a=0.0˜10.6;
b=0˜0.30;
c is a number satisfying the valence; and
the catalyst is prepared by the following steps:
(i) grinding and mixing the metal oxide precursors in desired amounts to obtain a mixture; and
(ii) placing the mixture in a ball milling jar, adding milling ball, and grinding to obtain an active substance of the ferrite catalyst;
(iii) mixing the resultant active substance of the ferrite catalyst with graphite, and molding to produce the catalyst.

2. The ferrite catalyst according to claim 1, wherein D is one or more atoms selected from the group consisting of Ni atom, Co atom and Mn atom.

3. The ferrite catalyst according to claim 1, wherein a=0.05˜0.5.

4. The ferrite catalyst according to claim 1, wherein the oxide precursor is selected from a single oxide or a mixture of oxides, and the precursors are sieved to obtain particles having a particle size of less than 0.1 mm.

5. The ferrite catalyst according to claim 1, wherein the mass ratio between milling ball and the raw material is 30˜10:1.

6. The ferrite catalyst according to claim 1, wherein the oscillation frequency of the ball mill is 22˜28 Hz.

7. The ferrite catalyst according to claim 1, wherein the milling time is 30˜800 minutes.

8. A method for forming the ferrite catalyst of claim 1, comprising the steps of:
(i) grinding and mixing the metal oxide precursors in desired amounts to obtain a mixture; and
(ii) placing the mixture in a ball milling jar, adding milling ball, and grinding to obtain an active substance of the ferrite catalyst;
(iii) mixing the resultant active substance of the ferrite catalyst with graphite, and molding to produce the catalyst.
